(19) United States
(12) Patent Application Publication
(10) Pub. No.: US 2026/0180003 A1
(43) Pub. Date: Jun. 25, 2026

(54) TARGETED OXIDATION SOLVENT FOR REGENERATION OF WASTE LITHIUM-ION CATHODE MATERIAL, AND USE THEREOF

(71) Applicant: KUNMING UNIVERSITY OF SCIENCE AND TECHNOLOGY, Kunming (CN)

(72) Inventors: Peng DONG, Kunming (CN); Qi MENG, Kunming (CN); Zitong FEI, Kunming (CN); Yingie ZHANG, Kunming (CN)

(21) Appl. No.: 18/712,615

(22) PCT Filed: Nov. 23, 2023
(86) PCT No.: PCT/CN2023/133491

§ 371 Date: May 22, 2024

(30) Foreign Application Priority Data
Nov. 26, 2022 (CN) 202211494768.X

(51) Int. Cl. H01M 10/052; H01M 4/36; H01M 4/525; H01M 10/0525; H01M 10/54

(52) U.S. Cl. CPC H01M 10/052; H01M 4/366; H01M 4/525; H01M 10/0525; H01M 10/54

(57) ABSTRACT

Disclosed are a targeted oxidation solvent for regeneration of a waste lithium-ion cathode material, and use thereof. The targeted oxidation solvent includes sodium methylene dinaphthalene sulfonate and tetrahydronaphthalene in a mass-to-volume ratio of 0.33 to 0.45 g/mL, and the targeted oxidation solvent is obtained by dissolving the sodium methylene dinaphthalene sulfonate in the tetrahydronaphthalene.

### CROSS REFERENCE TO RELATED APPLICATION

The present application claims priority of a Chinese Patent Application No. 202211494768.X filed with the China National Intellectual Property Administration (CNIPA) on Nov. 26, 2022 and entitled “TARGETED OXIDATION SOLVENT FOR REGENERATION OF WASTE LITHIUM-ION CATHODE MATERIAL, AND USE THEREOF”, which is incorporated herein by reference in its entirety.

### TECHNICAL FIELD

The present disclosure belongs to the technical field of recycling of waste lithium-ion cathode materials, and particularly relates to a targeted oxidation solvent for regeneration of a waste lithium-ion cathode material, and use thereof.

### BACKGROUND

After a cathode material of a lithium-ion battery undergoes long-term charge-discharge cycles, a part of lithium in the cathode material will remain in a negative electrode and cannot be deintercalated to produce dead lithium, resulting in a loss of lithium in the cathode material. Therefore, lithium supplementation is usually required in regeneration of a cathode material to produce a regenerated cathode material that can be used in a lithium-ion battery. However, in many studies, the problem of oxygen imbalance in waste cathode materials has been ignored, which is also crucial for regeneration of waste cathode materials. Currently, there are many methods for regeneration of cathode materials of lithium-ion batteries, but these methods still have shortcomings such as high cost, uneven lithium supplementation, inability to allow oxygen supply, and poor crystallization of particles. In addition, these methods usually require calcination at a high temperature, which has problems such as complicated process, inhomogeneous reactions, high energy consumption, and harsh conditions.

### SUMMARY

A first object of the present disclosure is to provide a targeted oxidation solvent for regeneration of a waste lithium-ion cathode material, and a second object of the present disclosure is to provide use of the targeted oxidation solvent.

The first object of the present disclosure is achieved by the following technical solutions. The present disclosure provides a targeted oxidation solvent for regeneration of a waste lithium-ion cathode material, where the targeted oxidation solvent includes sodium methylene dinaphthalene sulfonate and tetrahydronaphthalene in a mass-to-volume ratio of 0.33 to 0.45 g/mL, and the targeted oxidation solvent is obtained by dissolving the sodium methylene dinaphthalene sulfonate in the tetrahydronaphthalene.

The second object of the present disclosure is achieved by the following technical solutions. The present disclosure provides use of the targeted oxidation solvent in regeneration of a waste lithium-ion cathode material, including the following steps:
1) preparation of a pretreated waste lithium-ion cathode material: cutting a positive electrode sheet dismantled from a waste lithium battery into small pieces, adding the small pieces to the targeted oxidation solvent described above to obtain a mixture, stirring the mixture at a temperature of 40° C. to 70° C. for 40 min to 70 min, and filtering the mixture to obtain a black solid, which is the pretreated waste lithium-ion cathode material; and
2) adding an alkyl lithium compound and the pretreated waste lithium-ion cathode material to the targeted oxidation solvent described above to obtain a mixed system, stirring the mixed system for 20 min to 30 min, heating the mixed system to 50° C. to 120° C. in a vacuum drying oven, and reacting for 4 h to 12 h to obtain a reaction product, and subjecting the reaction product to suction filtration to obtain a solid, which is a regenerated cathode material.

Principles of the present disclosure are as follows:

The present disclosure provides a targeted oxidation solvent for regeneration of a waste lithium-ion cathode material. The targeted oxidation solvent could promote an oxidation-reduction reaction, and could make lithium ions selectively and directly hit lithium vacancies in a waste lithium-ion cathode material, such that lithium ion supplementation would not be locally over-enriched.

The targeted oxidation solvent includes sodium methylene dinaphthalene sulfonate and tetrahydronaphthalene that are excellently miscible with each other. Sodium methylene dinaphthalene sulfonate has excellent dispersibility, self-stability, acid resistance, alkali resistance, and heat resistance, and does not have permeability and foaming, which avoids the influence of self-decomposition of sodium methylene dinaphthalene sulfonate on a repair process of the waste lithium-ion battery. In addition, sodium methylene dinaphthalene sulfonate exhibits an affinity for an alkyl lithium compound or a phenyl lithium compound, and could be easily combined with anions of the alkyl lithium compound/phenyl lithium compound to release lithium ions, such that the lithium ions could be well supplemented in a waste lithium-ion cathode material. Tetrahydronaphthalene could serve as an oxygen donor to provide oxidation-reduction conditions for a system, and could also supplement oxygen for a waste lithium-ion cathode material. In addition, tetrahydronaphthalene does not volatilize with a water vapor. Therefore, tetrahydronaphthalene could serve as not only an automatic oxidant, but also a high-boiling-point solvent. Sodium methylene dinaphthalene sulfonate and tetrahydronaphthalene play a synergistic role in the repair process. Tetrahydronaphthalene could also serve as an absorbent of a steam during an evaporation and drying process of sodium methylene dinaphthalene sulfonate, and could effectively reduce a viscosity of a solution, which is conducive to the proceed of the reaction.

The present disclosure has the following beneficial effects:

1. The targeted oxidation solvent of the present disclosure could make an insoluble waste lithium-ion cathode material evenly dispersed in a solution without destroying a structure of the waste lithium-ion cathode material. In addition, sodium methylene dinaphthalene sulfonate could be perfectly combined with an alkyl lithium compound/phenyl lithium compound, which makes it possible to supplement lithium ions in a targeted way, thereby repairing structural defects in a destroyed waste lithium-ion cathode material; thus, the targeted oxidation solvent could be used to replace expensive eutectic solvents. Moreover, when the targeted oxidation solvent is used for regeneration of the waste lithium-ion cathode material, only non-toxic gases such as carbon dioxide are released during the whole process, which is eco-friendly. Further, in the regeneration method of the present disclosure, an alkyl lithium compound or a phenyl lithium compound is used as a lithium source, and the alkyl lithium compound or the phenyl lithium compound is cheaper than lithium carbonate and lithium hydroxide used in the prior art, which further reduces a cost. In addition, the targeted oxidation solvent of the present disclosure is more resistant to high temperatures than eutectic solvents, such that the problem of the eutectic solvents that it is easy to volatilize to produce gases such as methane and acetylene could be avoided; thus, the targeted oxidation solvent is safer than the eutectic solvents.

2. The method for regeneration of the waste lithium-ion cathode material with the targeted oxidation solvent provided by the present disclosure has simple and easy operations, and has no strict requirement for temperature of the regeneration reaction, which could be easily popularized and applied.

### BRIEF DESCRIPTION OF THE DRAWINGS

FIG. 1 is a scanning electron microscopy (SEM) image of a waste cathode material W-LCO;

FIG. 2 is an SEM image of the regenerated cathode material prepared in Comparative Example 1;

FIG. 3 is an SEM image of the regenerated cathode material prepared in Comparative Example 2;

FIG. 4 is an SEM image of the regenerated cathode material prepared in Example 1;

FIG. 5 is an SEM image of the regenerated cathode material prepared in Example 4;

FIG. 6 shows transmission electron microscopy (TEM) images of the waste cathode material W-LCO, where a left panel shows a lattice fringe and a right panel shows a diffraction spot of a structure;

FIG. 7 shows TEM images of Example 1, where a left panel shows a lattice fringe and a right panel shows a diffraction spot of a structure;

FIG. 8 shows TEM images of Comparative Example 1, where a left panel shows a lattice fringe and a right panel shows a diffraction spot of a structure; and

FIG. 9 shows a capacity retention rate of a battery with the lithium cobalt oxide cathode material prepared in Example 1 after 103 cycles.

### DETAILED DESCRIPTION OF THE EMBODIMENTS

The present disclosure is further described in detail below in conjunction with examples, but is not limited thereto in any way. Any transformation or modification made based on the teachings of the present application falls within the scope of the present application.

The present disclosure provides a targeted oxidation solvent for regeneration of a waste lithium-ion cathode material, where the targeted oxidation solvent includes/consists of sodium methylene dinaphthalene sulfonate and tetrahydronaphthalene in a mass-to-volume ratio of 0.33 to 0.45 g/mL, and the targeted oxidation solvent is obtained by dissolving the sodium methylene dinaphthalene sulfonate in the tetrahydronaphthalene.

In some embodiments, dissolving the sodium methylene dinaphthalene sulfonate in the tetrahydronaphthalene is performed at a temperature of 35° C. to 40° C. under stirring for 30 s to 60 s.

The present disclosure also provides use of the targeted oxidation solvent described above in regeneration of a waste lithium-ion cathode material, including the following steps:
1) preparation of a pretreated waste lithium-ion cathode material: a positive electrode sheet dismantled from a waste lithium battery is cut into small pieces and added to the targeted oxidation solvent described above to obtain a mixture, and the mixture is stirred at a temperature of 40° C. to 70° C. for 40 min to 70 min and filtered to obtain a black solid, which is the pretreated waste lithium-ion cathode material; and
2) an alkyl lithium compound and the pretreated waste lithium-ion cathode material are added to the targeted oxidation solvent described above to obtain a mixed system, the mixed system is stirred for 15 min to 30 min and heated to a temperature of 50° C. to 120° C. in a vacuum drying oven, and subjected to reaction for 4 h to 12 h to obtain a reaction product, and the reaction product is subjected to suction filtration to obtain a solid, which is a regenerated cathode material.

In some embodiments, in step 2), a mole-to-volume ratio of the alkyl lithium compound to the targeted oxidation solvent is in a range of 0.1 to 0.7 mol/mL.

In some embodiments, in step 2), a mole-to-volume ratio of the pretreated waste lithium-ion cathode material to the targeted oxidation solvent is in a range of 0.4 to 1.0 mol/mL. In some embodiments, the alkyl lithium compound is selected from the group consisting of butyl lithium, ethyl lithium, and methyl lithium.

### Example 1

19.5 g of sodium methylene dinaphthalene sulfonate was added to 50 mL of tetrahydronaphthalene (analytically pure) to obtain a mixture, and the mixture was heated and stirred by a magnetic stirrer at 35° C. for 45 s to allow dissolution to obtain a targeted oxidation solvent. A positive electrode sheet dismantled from a waste lithium cobalt oxide battery was cut into small pieces and added to the targeted oxidation solvent, and a resulting mixture was stirred at 55° C. for 55 min and then filtered to obtain a black solid, which was a pretreated waste lithium cobalt oxide powder.

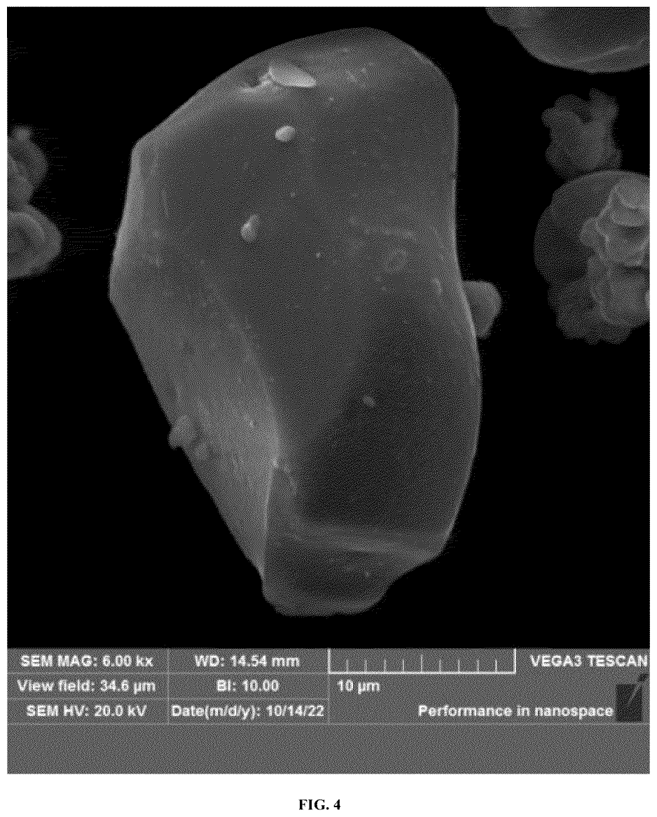

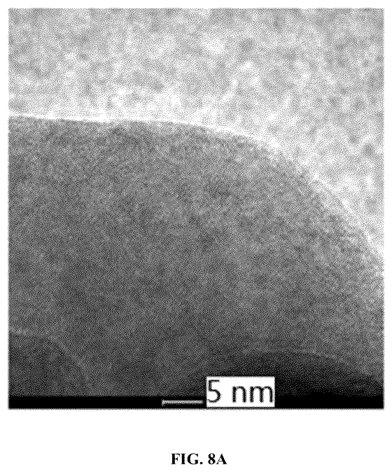

To the targeted oxidation solvent, n-butyl lithium was added in a mole-to-volume ratio of 0.4 mol/mL, and the pretreated waste lithium cobalt oxide powder was added in a mole-to-volume ratio of 0.7 mol/mL. A resulting mixture was stirred for 20 min, heated to 80° C. in a vacuum drying oven, and subjected to reaction for 7 h, and then a resulting system was subjected to suction filtration to obtain a solid, which was a regenerated lithium cobalt oxide powder (DR-DLCO₂). SEM and TEM images of the regenerated lithium cobalt oxide powder are shown in FIG. 4 and FIG. 8, respectively.

### Example 2

22.5 g of sodium methylene dinaphthalene sulfonate was added to 50 mL of tetrahydronaphthalene (analytically pure) to obtain a mixture, and the mixture was heated and stirred by a magnetic stirrer at 40° C. for 60 s to allow dissolution to obtain a targeted oxidation solvent. A positive electrode sheet dismantled from a waste lithium cobalt oxide battery was cut into small pieces and added to the targeted oxidation solvent, and a resulting mixture was stirred at 40° C. for 70 min and then filtered to obtain a black solid, which was a pretreated waste lithium cobalt oxide powder.

To the targeted oxidation solvent, n-butyl lithium was added in a mole-to-volume ratio of 0.7 mol/mL, and the pretreated waste lithium cobalt oxide powder was added in a mole-to-volume ratio of 1 mol/mL. A resulting mixture was stirred for 30 min, heated to 50° C. in a vacuum drying oven, and subjected to reaction for 12 h, and then a resulting system was subjected to suction filtration to obtain a solid, which was a regenerated lithium cobalt oxide powder.

### Example 3

16.5 g of sodium methylene dinaphthalene sulfonate was added to 50 mL of tetrahydronaphthalene (analytically pure) to obtain a mixture, and the mixture was heated and stirred by a magnetic stirrer at 50° C. for 30 s to allow dissolution to obtain a targeted oxidation solvent. A positive electrode sheet dismantled from a waste lithium cobalt oxide battery was cut into small pieces and added to the targeted oxidation solvent, and a resulting mixture was stirred at 70° C. for 40 min and then filtered to obtain a black solid, which was a pretreated waste lithium cobalt oxide powder.

To the targeted oxidation solvent, n-butyl lithium was added in a mole-to-volume ratio of 0.1 mol/mL, and the pretreated waste lithium cobalt oxide powder was added in a mole-to-volume ratio of 0.4 mol/mL. A resulting mixture was stirred for 15 min, heated to 120° C. in a vacuum drying oven, and subjected to reaction for 4 h, and then a resulting system was subjected to suction filtration to obtain a solid, which was a regenerated lithium cobalt oxide powder.

### Example 4

Example 4 was performed according to the method of Example 1, except that the lithium source was phenyl lithium.

### Example 5

Example 5 was performed according to the method of Example 1, except that the lithium source was ethyl lithium.

### Example 6

Example 6 was performed according to the method of Example 1, except that the lithium source was methyl lithium.

### Comparative Example 1

Comparative Example 1 was performed according to the method of Example 1, except that the targeted oxidation solvent was replaced with homologous dimethyl sulfoxide (DMSO).

### Comparative Example 2

Comparative Example 2 was performed according to the method of Example 1, except that the targeted oxidation solvent was replaced with N,N-dimethylformamide (DMF).

### Test Example 1

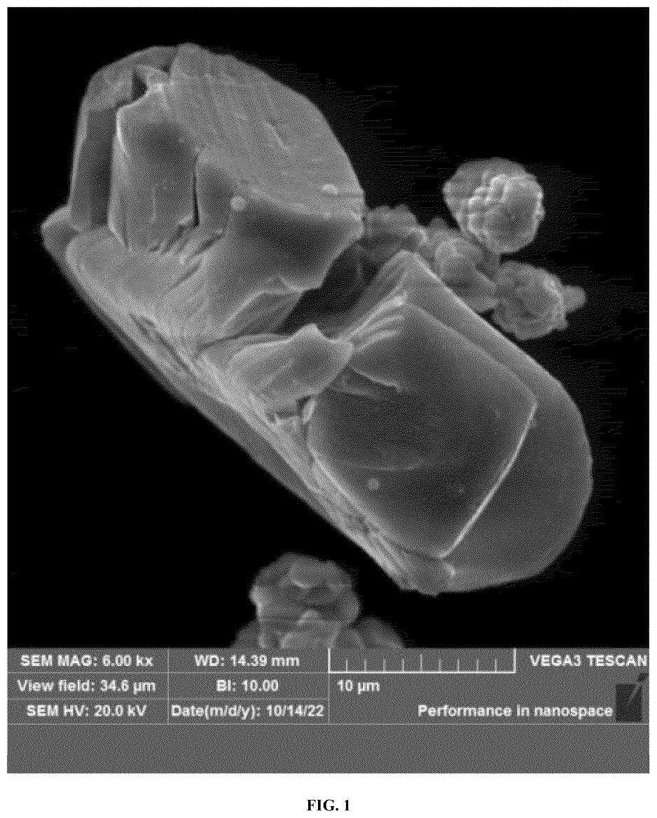

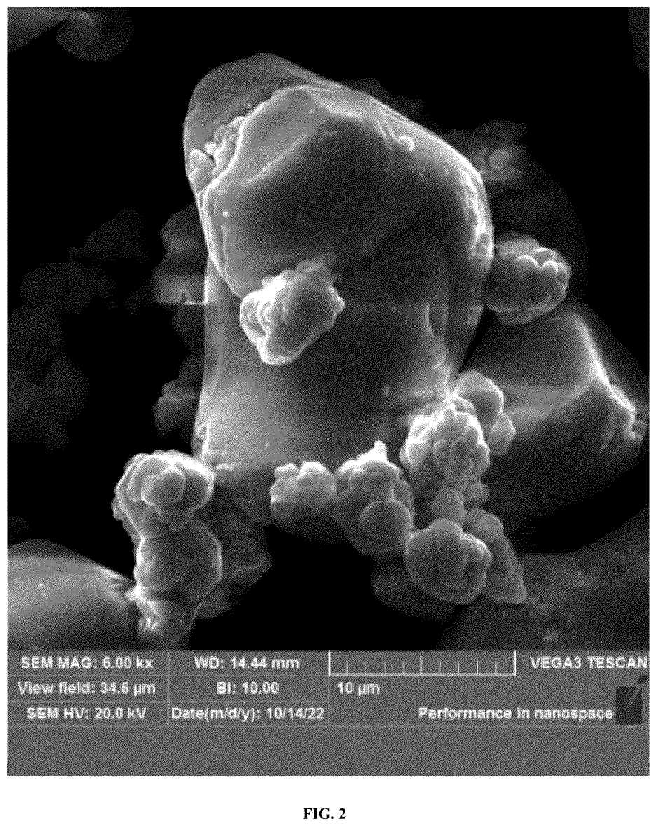

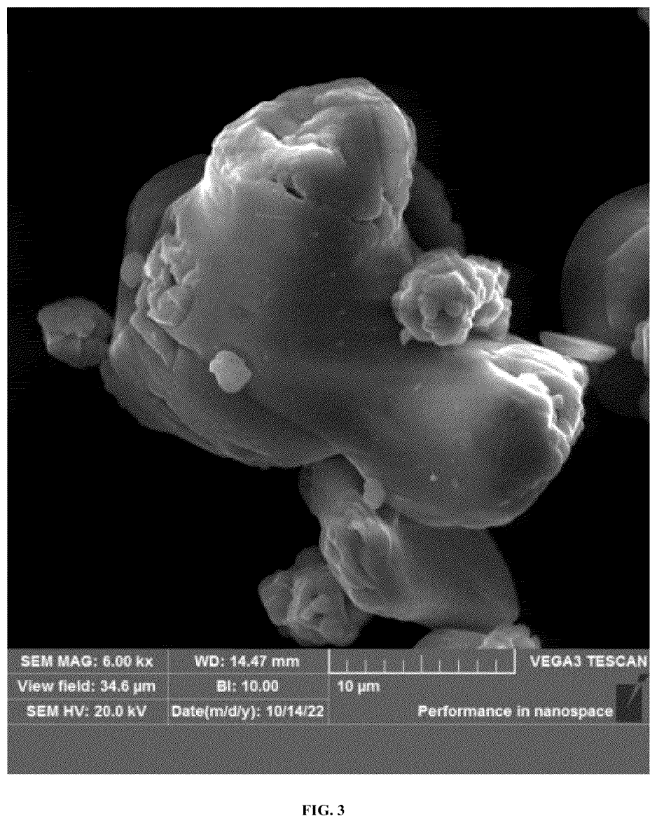

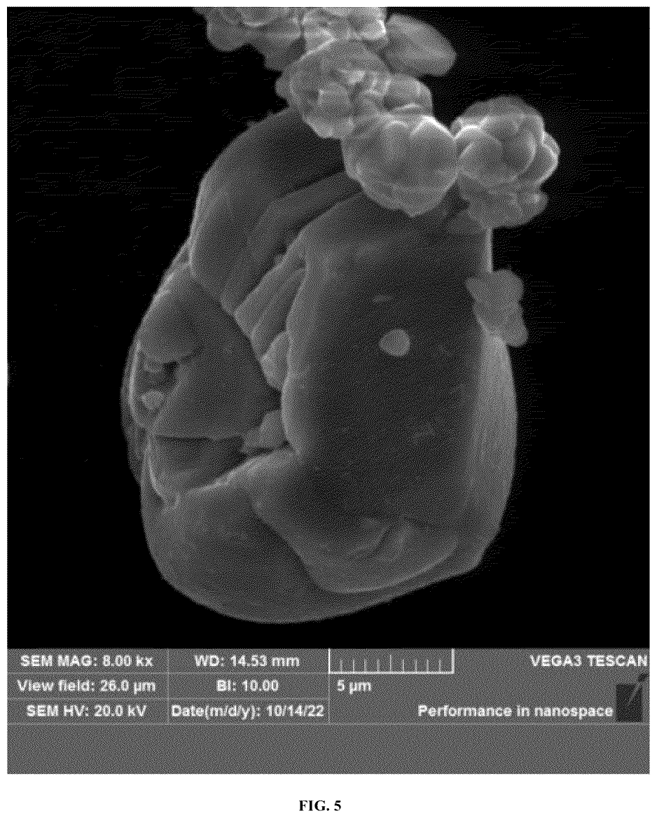

The regenerated cathode materials prepared in Example 1, Example 4, and Comparative Examples 1 and 2 were subjected to SEM analysis, and analysis results are shown in FIG. 2 to FIG. 5. Obviously, the waste lithium cobalt oxide material (raw materials) in FIG. 1 undergoes a crystal fracture and a crystal plane slip. In the regenerated lithium cobalt oxide material obtained in Example 1 (FIG. 4), phenomena such as particle fractures are effectively repaired, and the regenerated lithium cobalt oxide material has a smooth surface and full particles and is free of cracks and other impurities. However, in the regenerated lithium cobalt oxide materials of Comparative Example 1 (FIG. 2) and Comparative Example 2 (FIG. 3), cracks are slightly repaired and are obviously filled by lithium. However, due to a poor catalytic effect of a solvent, a repair degree is low, there are still slight cracks, and lithium salts attached to a surface cannot fully react, which cannot meet the needs of a material. In the regenerated lithium cobalt oxide material obtained in Example 4 (FIG. 5), particle cracks are repaired, and there are no obvious impurity particles. However, due to a poor affinity of the phenyl lithium with the solution, a repair driving force is weak and a required energy barrier is high; thus, the regenerated lithium cobalt oxide material obtained in Example 4 has insufficient surface smoothness compared with Example 1.

### Test Example 2

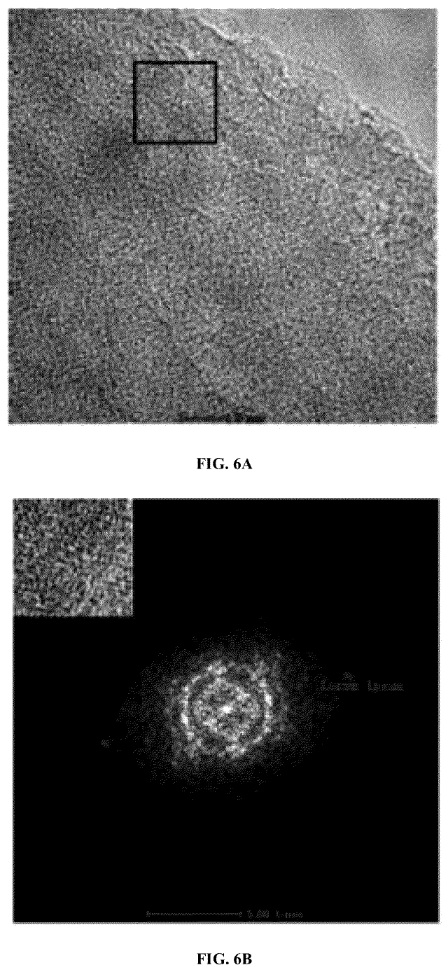

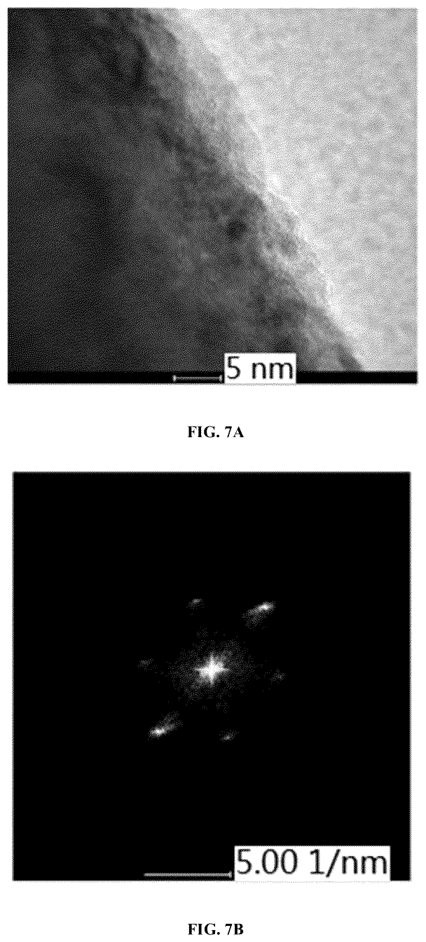

The regenerated cathode materials prepared in Example 1 and Comparative Example 1 were subjected to TEM analysis, and analysis results are shown in FIG. 6 to FIG. 8. From FIG. 6 to FIG. 8, it can be seen that lattice fringes in the waste material are blurred. From diffraction spots of the waste material structure, it can be inferred that a local halite phase structure is produced, indicating that a layered structure of the waste material is destroyed. Lattice fringes of the regenerated material obtained in Example 1 are clear, and diffraction spots of the regenerated material show a clear layered structure with clear boundary lines, indicating that a lattice structure of the regenerated material is repaired. In the regenerated material obtained in Comparative Example 1, particles are repaired outside, but there is a lamination phenomenon inside the particles, which is due to a lack of local structure repair caused by an uneven reaction process.

Test Example 3 Cycling performance tests of batteries with the regenerated cathode materials obtained in Example 1 and Comparative Example 1

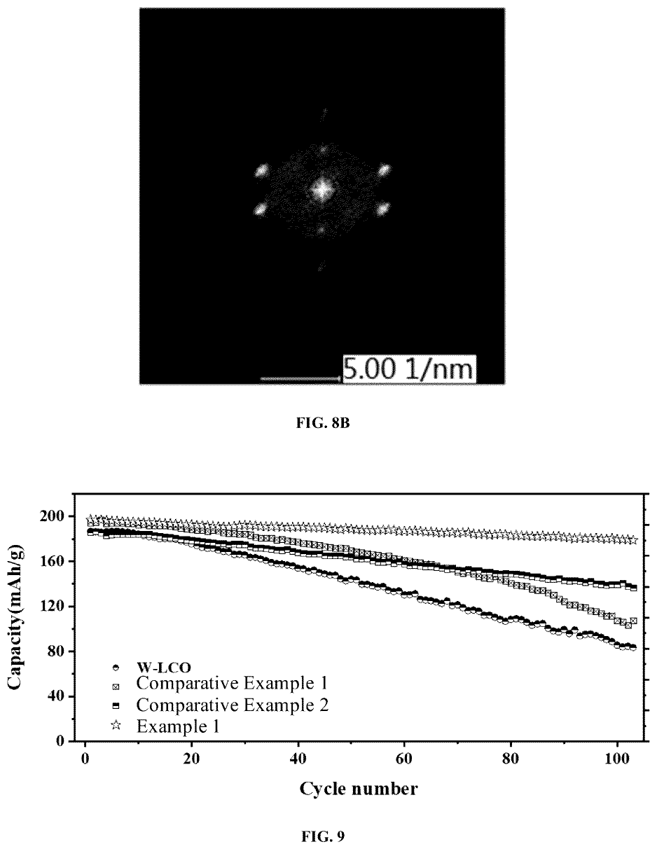

Cycling performance results are shown in Table 1 and FIG. 9. The results show that a capacity retention rate of the regenerated lithium cobalt oxide material prepared by the present disclosure after 103 cycles is as high as 90.7%, indicating that electrochemical performance of the material is restored and meets a standard for commercial materials of consumer 3C products.

TABLE 1
Charge-discharge test results of the batteries with
the regenerated lithium cobalt oxide materials obtained
in Example 1 and Comparative Example 1

| | Specific discharge | | |
|---|---|---|---|
| | capacity (mAh/g) | | |
| | After 1 | After 103 | Capacity retention rate |
| No. | cycle | cycles | after 103 cycles (%) |
| Example 1 | 197.052 | 178.724 | 90.7 |
| Comparative | 186.079 | 136.406 | 73.3 |
| Example 1 | | | |
| Comparative | 194.516 | 107.274 | 55.1 |
| Example 2 | | | |
| Waste lithium-ion | 186.756 | 83.547 | 44.7 |
| cathode material | | | |

The present disclosure has been disclosed with preferred embodiments as above, which shall not be construed as a limitation to the present disclosure. Any person skilled in the art could make changes and variations without departing from the spirit and scope of the present disclosure. Therefore, the scope of the present disclosure should be defined by the claims.

1. A targeted oxidation solvent for regeneration of a waste lithium-ion cathode material, wherein the targeted oxidation solvent comprises sodium methylene dinaphthalene sulfonate and tetrahydronaphthalene in a mass-to-volume ratio of 0.33 to 0.45 g/mL, and the targeted oxidation solvent is obtained by dissolving the sodium methylene dinaphthalene sulfonate in the tetrahydronaphthalene.

2. The targeted oxidation solvent of claim 1, wherein dissolving the sodium methylene dinaphthalene sulfonate in the tetrahydronaphthalene is performed at a temperature of 30° C. to 50° C. under stirring for 30 s to 60 s.

3. A regeneration reagent, consisting of the targeted oxidation solvent of claim 1 and an alkyl lithium compound.

4. A method for regeneration of a waste lithium-ion cathode material, comprising the following steps:
1) preparation of a pretreated waste lithium-ion cathode material: cutting a positive electrode sheet dismantled from a waste lithium battery into small pieces, adding the small pieces to the targeted oxidation solvent of claim 1 to obtain a mixture, stirring the mixture at a temperature of 40° C. to 70° C. for 40 min to 70 min, and filtering the mixture to obtain a black solid, which is the pretreated waste lithium-ion cathode material; and
2) adding an alkyl lithium compound and the pretreated waste lithium-ion cathode material to the targeted oxidation solvent of claim 1 to obtain a mixed system, stirring the mixed system for 15 min to 30 min, heating the mixed system to 50° C. to 120° C. in a vacuum drying oven, and reacting for 4 h to 12 h to obtain a reaction product, and subjecting the reaction product to suction filtration to obtain a solid, which is a regenerated cathode material.

5. The method of claim 4, wherein in step 2), a mole-to-volume ratio of the alkyl lithium compound to the targeted oxidation solvent is in a range of 0.1 to 0.7 mol/mL.

6. The method of claim 4, wherein in step 2), a mole-to-volume ratio of the pretreated waste lithium-ion cathode material to the targeted oxidation solvent is in a range of 0.4 to 1.0 mol/mL.

7. The method of claim 4, wherein in step 2), the alkyl lithium compound is selected from the group consisting of butyl lithium, ethyl lithium, and methyl lithium.

8. The regeneration reagent of claim 3, wherein the alkyl lithium compound is replaced with a phenyl lithium compound.

9. The method of claim 7, wherein the butyl lithium is n-butyl lithium.

10. The method of claim 4, wherein the waste lithium-ion cathode material is a cathode material of a waste lithium cobalt oxide battery.

11. The method of claim 4, wherein dissolving the sodium methylene dinaphthalene sulfonate in the tetrahydronaphthalene is performed at a temperature of 30° C. to 50° C. under stirring for 30 s to 60 s.
